(19) United States
(12) Patent Application Publication
(10) Pub. No.: US 2014/0289519 A1
(43) Pub. Date: Sep. 25, 2014

(54) ENTITIES WITH BIOMETRICALLY DERIVED KEYS

(71) Applicant: HEWLETT-PACKARD DEVELOPMENT COMPANY, L.P., Houston, TX (US)

(72) Inventor: Justin E. York, Cypress, TX (US)

(73) Assignee: Hewlett-Packard Development Company, L.P., Houston, TX (US)

(21) Appl. No.: 13/849,271

(22) Filed: Mar. 22, 2013

(51) Int. Cl. H04L 29/06

(52) U.S. Cl. CPC H04L 63/0428
USPC 713/168

(57) ABSTRACT

Techniques for introducing managed entities to management entities are provided. A presence notification message encrypted with a biometrically derived key may be sent by a managed entity. A management entity may receive the encrypted presence notification message and attempt to decrypt the message. The management entity may encrypt a command message with the biometrically derived key. The managed entity may decrypt the command message.

### BACKGROUND

Modern computer data centers may contain hundreds, thousands, or even hundreds of thousands of entities that need to be managed. Some examples of managed entities can include servers, switches, routers, storage elements, and any number of other types of entities. Each of these entities may have interactions with other entities. For example, a server may be coupled to one or more storage devices through various switches and routers. Management of the data center through management of the entities individually can be extraordinarily complex.

To overcome the complexity in data center management, centralized management software, running on a management entity has been created. Using the management entity, a system administrator may be able to see the data center as a whole, and may holistically manage the data center. The management entity may then take responsibility for translating the system wide view into commands that are directed to individual managed entities. Thus, the system administrator is relieved form having to manage each entity as an individual entity.

### BRIEF DESCRIPTION OF THE DRAWINGS

FIG. 1 is an example of a system utilizing the techniques described herein to introduce managed and management entities using biometrically derived keys.

FIG. 2 is an example high level flow diagram for authenticating a managed entity using the techniques described herein.

FIG. 3 is another example high level flow diagram for authenticating a managed entity using the techniques described herein.

FIG. 4 is an example high level flow diagram for authenticating a management entity using the techniques described herein.

FIG. 5 is another example high level flow diagram for authenticating a management entity using the techniques described herein.

### DETAILED DESCRIPTION

The use of management entities has greatly reduced the complexity of managing the modern data center. A management entity provides a centralized point for a system administrator to manage the data center, while at the same time relieving the system administrator from having to manage entities individually. Although management entities simplify the process of managing the data center, the use of management entities creates another problem.

In order to properly manage an entity, the management entity needs a very low level of access to the managed device. For example, in the case of a server, the management entity may need access to low level Basic Input/Output System (BIOS) configuration parameters. Likewise, for routers and switches, the management entity may need to be able to reconfigure the operation of the various ports on the routers and switches. Similar concerns exist for storage devices. In many cases, improper configuration may lead to inoperable entities within the data center. Given the amount of control the management entity has over the managed entity, security is a concern.

The security problem is exacerbated when a new managed entity is to be added to the data center. For example, if a new server is added to the data center, the new server typically does not know anything about management entities within the data center. Likewise, the management entity may not initially know anything about the new managed entity that is being added to the data center. As a first step, the management entity and the newly added managed entity must be properly introduced to each other, such that a trust relationship may be established.

Techniques provided herein provide for a mechanism for a management entity and a managed entity that initially know nothing about each other to establish a trust relationship. The relationship is based on biometrically derived information. Initially, all persons who are authorized to introduce new managed entities into the data center may provide biometric identification information. This information may be used to derive a key for each person, and the key is accessible to the management entity. When a new managed entity is added to the data center, the person adding the managed entity provides biometric identification information to the new managed entity.

The new managed entity may then derive a key based on this biometric information, using the same process used by the management entity. Thus, the biometric identification information from a given person may cause the same key to be derived. The newly added managed entity may then announce its presence within the data center with a presence notification message encrypted using the derived key. The encryption may be such that proper decryption requires knowledge of the key used to perform the encryption.

The management entity may receive this presence notification, and attempt to decrypt the message using the previously derived keys. A successful decryption indicates that the newly added managed entity is being added by a person who is authorized to add new entities. Furthermore, the particular person adding the entity is known, because only that person's derived key would be able to decrypt the presence notification message. In addition, it can be guaranteed that, unlike the case of a username and password which can be used by anyone, the person adding the entity is actually authorized to add entities.

The management entity may then respond to the newly added managed entity with a command message. The command message may be encrypted with the biometrically derived key. Upon receipt, the newly added managed entity may attempt to decrypt the command message. If the command message is successfully decrypted, this means it was encrypted by an entity that has knowledge of at least the person who is adding the managed entity.

Thus, the managed entity can be ensured that the command message was received from a trusted system.

In one example implementation, the management entity may create an individual password for the newly added managed entity that is unique. The command message may contain further information, such as an instruction to set a password on the managed entity to the password created by the management entity. Future interactions between the management entity and the managed entity may utilize this unique password. Thus, the use of default or easily obtained passwords may be eliminated. The command message can include any other instructions for the managed entity as well. What should be understood is that because a secure trust relationship has been established, the managed entity can trust that whatever is contained in the command message came from a legitimate management entity.

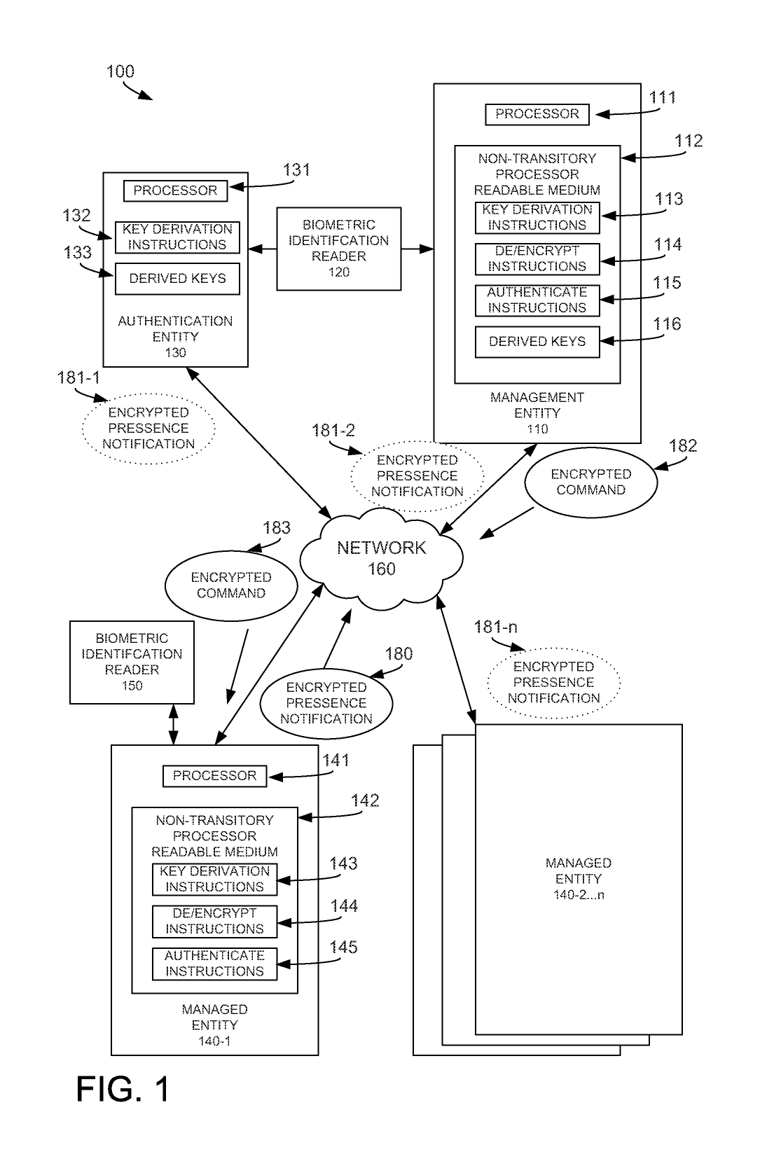

FIG. 1 is an example of a system utilizing the techniques described herein to introduce managed and management entities using biometrically derived keys. System 100 may include a management entity 110, a biometric identification reader 120, an authentication entity 130, managed entities 140-1 . . . n, a biometric identification reader 150, and a network 160. The network 160 may be used to communicatively couple the previously mentioned entities. For example, the network 160 may be an Ethernet network, and intranet, the Internet, or any other network that allows computing devices to communicate with each other.

The management entity 110 may be a device, such as a computer, that runs software to enable management of a datacenter, or other collection of managed entities. The management entity may include a processor 111. Coupled to the processor may be a non-transitory processor readable medium 112 containing instructions thereon. These instructions, when executed, may cause the management entity to implement the techniques described herein. For example, the medium 112 may contain instructions for deriving keys 113, encrypting and decrypting messages 114, authentication instructions 115, and storage for derived keys 116.

In some example implementations, a biometric identification reader 120 may be coupled to the management entity 110. The biometric identification reader may be integrated within the management entity, or may be a device that is connected to the management entity. For example, the biometric identification reader may plug in to the management entity via an external port, such as a Universal Serial Bus (USB) port. The biometric identification reader may be able to receive biometric identification information from a user and provide that information in an electronic form. One example of a biometric identification reader may be a fingerprint scanner. Other types may include retinal scanners, DNA scanners, or any other type of device that is able to receive information that identifies an individual base on biological traits that are effectively unique to that individual and are immutable. The biological identification reader may pass this information to the management entity for further processing, described below.

In some example implementations, the biological identification reader is coupled to an authentication entity. The authentication entity may be a device, such as a computer, that contains a processor 131. The processor may be coupled to a non-transitory processor readable medium containing instructions thereon (not shown). These, instructions, such as key derivation instructions 132 and derived key storage 133, are described in further detail below. In general, the authentication entity may be used to centralize some of the authentication process as is described below.

The system 100 may also include managed entities 140-1, . . . n. Managed entities, as described above, are any type of entity that is connected to the network that may be managed by the management entity. For example, managed entities may include computers, routers, switches, storage devices, or any other type of entity that can be managed from the management entity. For purposes of simplicity of explanation, only a single managed entity 140-1 is described in detail, however it should be understood that all managed entities may have a similar structure.

Managed entity 140-1 may include a processor 141. Coupled to the processor may be a non-transitory processor readable medium 142 containing instructions thereon. These instructions, when executed, may cause the managed entity to implement the techniques described herein. For example, the medium 142 may contain instructions for deriving keys 143, encrypting and decrypting messages 144, and authentication instructions 145. It should be noted that the instructions on the managed entity are substantially the same as the instructions on the management entity, such that given the same inputs, the same output is provided. Further explanation of the operation of the instructions is described below.

Coupled to the managed devices may be a biometric identification reader 150. Biometric identification reader 150 may be similar to the reader 140 described above. Just as above, the biometric identification reader 150 may be integrated within managed device 140-1, or it may couple to the managed device through an external port, such as a USB port. Again, just as above, the biometric identification reader is able to receive identification information from a user.

System 100 in operation will now be described. During an initial setup phase, the management entity 110 may receive, through the biometric identification reader 120, biometric identification information from all users that are authorized to introduce new managed entities to the management entity. Using the key derivation instructions, the management entity may take the received biometric identification information and derive a key. This key may be referred to as a biometrically derived key.

The particular mechanism for deriving the key is unimportant, however the mechanism should be repeatable. In other words, given biometric identification information from a specific individual, the same key should be derived. For example, if a given individual provides his fingerprint several times, the key derivation instructions result in the same key being generated. In other words, the biometrically derived key uniquely identifies the individual and can be reliably derived based on the biometric identification information provided by that user. The biometrically derived key for each authorized user may be stored as derived keys 116. Use of the derived keys is explained in further detail below.

In an alternate example implementation, the biometric identification information is provided to the authentication entity 130. The authentication entity, using the key derivation instructions 132 may derive the biometrically derived keys and store them 133. The authentication entity may then make the biometrically derived keys available for use by the management entity. In addition, the authentication entity may be a central repository for authentication information for all user, not just those that are authorized to add new managed entities. For example, the authentication entity may be a role based authentication entity. A role may be defined that includes authorization to add new managed entities. For each user assigned to this role, the authentication entity may store a biometrically derived key. If the role is removed from a particular user, the biometrically derived key may no longer be provided to the management entity.

Regardless of particular implementation, what should be understood is that the management entity has access to the biometrically derived keys for each user that is authorized to add new managed entities. It should be understood that the initialization phase is ongoing. New user may be authorized and previously authorized user may be removed. What should be clear is that management entity is aware of the biometrically derived keys for all authorized users.

In the operational phase, a new managed entity may need to be associated with the management entity. For example, managed entity 140-1 may be a managed entity that is being installed within the system 100, As part of the installation process, the user that is performing the installation may provide biometric identification information to the managed entity 140-1 through the biometric identification reader 150. The managed entity 140-1 may then execute the key derivation instructions 143 in order to create a biometrically derived key. It should be understood that the key derivation instructions 113 and 143 are essentially the same. This means that regardless of which instructions are executed, if the same biometric identification information is presented, the same key will be derived.

The newly added management entity 140-1 may then create a presence notification message (not shown). The presence notification message is a message that may be used by the managed entity 140-1 to announce its presence on network 160. Using the de/encrypt instructions 144, at least a portion of the presence notification message may be encrypted. The encryption may be based in part on the biometrically derived key of the user installing the new managed entity 140-1.

The particular encryption mechanism used is unimportant, so long as the encryption is symmetric. In symmetric encryption, a message encrypted by a key may only be decrypted using the same key. Thus, if a message is encrypted by the biometrically derived key of a user, the message can only be decrypted by an entity that is also in possession of the biometrically derived key for that user.

The new managed entity 140-1 may then broadcast the encrypted presence notification message 180 over the network 160. Because the message is broadcast, all entities attached to the network will receive the broadcast encryption message 181-1 . . . n. The management entity may receive the message and attempt to decrypt the message using the available biometrically derived keys (either from the internal derived keys 116 or the authentication entity 130). In other words, the management entity may use the authenticate instructions 115 to try to decrypt the encrypted presence notification message with each biometrically derived key known to the management entity.

If the decryption is successful, the management entity is ensured that the user installing the new managed entity 141-1 is authorized to do so. The reason for this is that because the encryption is symmetric, the management entity was only able to decrypt the message because it was encrypted by a biometrically derived key known to the management entity. Because the management entity attempts decryption with the biometrically derived keys of authorized users, this means the message was generated by an entity that was able to derive the key using biometric identification information. Because the biometric identification information used to derive a specific biometrically derived key can only be provided by a unique individual, it can be ensured that that individual was the one who is attempting to add the ne managed entity 141-1. Thus, the newly added managed entity 140-1 is able to authenticate itself to the management entity. It should be noted that if the management entity is not able to decrypt the presence notification message, this means that the message was generated by an unauthorized user attempting to introduce a new managed entity to the management entity.

The management entity 110, using the authenticate instructions 114 may generate a command message (not shown). The command message may be any type of command to be sent to the managed entity. For example, the managed entity may wish to instruct the managed entity to change its password to something known only to the management entity. The management entity may then, using the encryption instructions 114, encrypt the command message 182. The message may be encrypted using the biometrically derived key that was able to successfully decrypt the presence notification message.

The management entity may then send the encrypted command message to the new managed entity 140-1. It should be noted that this message need not be a broadcast message. The management entity is aware of the particular entity that sent the presence notification message, and as such can respond to just that entity.

The new managed entity 140-1 may then receive the encrypted command message 183. Using the decryption instructions 144 and the biometrically derived key that was used to encrypt the presence notification message, the new managed entity may attempt to decrypt the command message. If the decryption is successful, the authentication instructions 145 confirm to the new managed entity that the command message was received from a valid management entity. The reason this can be ensured is because of the use of the symmetric keys. The successful decryption of the command message indicates it came from an entity that knows the biometrically derived key of the user installing the new managed entity. Because such information should be known only be the management entity, the new managed entity is able to authenticate the management entity that sent the encrypted command message.

The new managed entity may then perform whatever actions, such as set a password, that were specified in the command message. It should be noted that if the command message is not received or cannot be successfully decrypted, this means that the managed entity should not be added. If the command is not received, this means that the management entity was not able to decrypt the presence notification message, which may occur if the user installing the new managed entity is not authorized. If the command is received, but cannot be decrypted, this means the command was generated by an entity that does not know the biometrically derived key of the user attempting to install the new managed entity. Since the management entity would know the authorized biometrically derived keys of all authorized users, this means that the responding entity is not an authorized management entity.

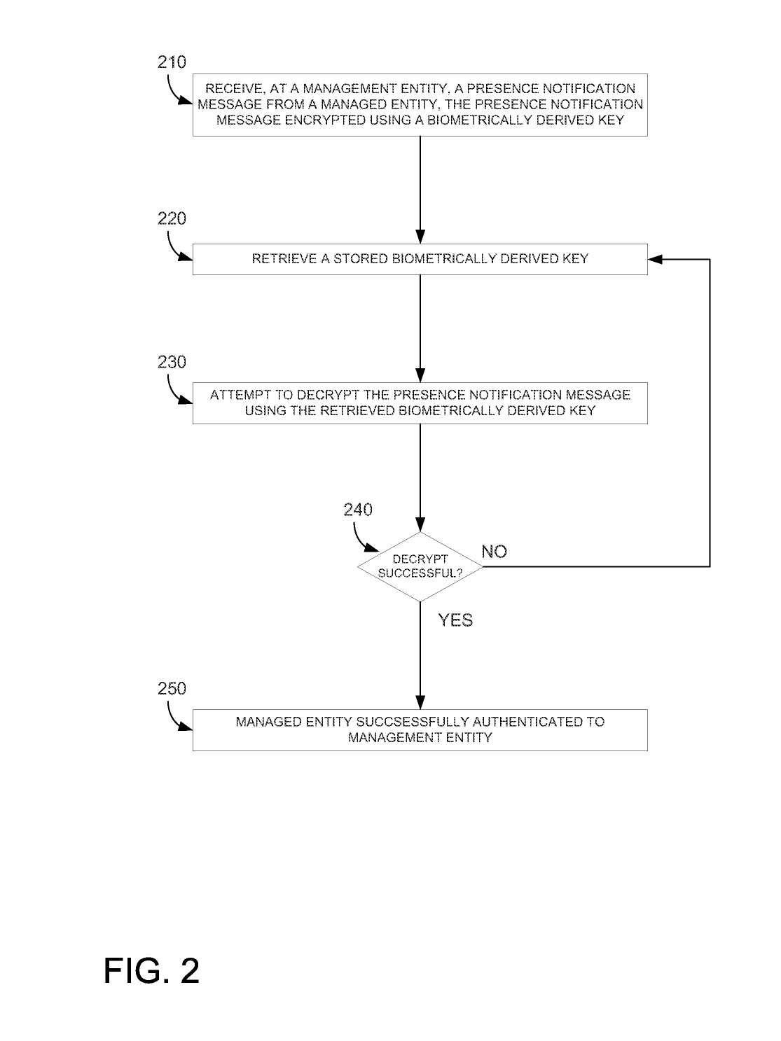

FIG. 2 is an example high level flow diagram for authenticating a managed entity using the techniques described herein. In block 210, a management entity may receive a presence notification message from a managed entity. The presence notification message may have been encrypted using a biometrically derived key. As mentioned above, a message encrypted with a biometrically derived key may be decrypted using the same key. In block 220, a stored biometrically derived key may be retrieved. The key may be stored within the management entity itself or may be store within an authentication entity.

In block 230, an attempt to decrypt the presence notification message using the retrieved biometrically derived key may be made. It block 240, it may be determined if the decryption attempt was successful. If not successful, the process returns to block 220, wherein another biometrically derived key is retrieved. As mentioned above, the management entity may try to decrypt the presence notification message with all known biometrically derived keys that are authorized to introduce managed entities. If the decryption is successful in block 240, the process moves to block 250. In block 250, the managed entity has successfully authenticated to the management entity. In other words, the management entity can ensure that the person attempting to introduce the managed entity to the management entity is authorized to do so.

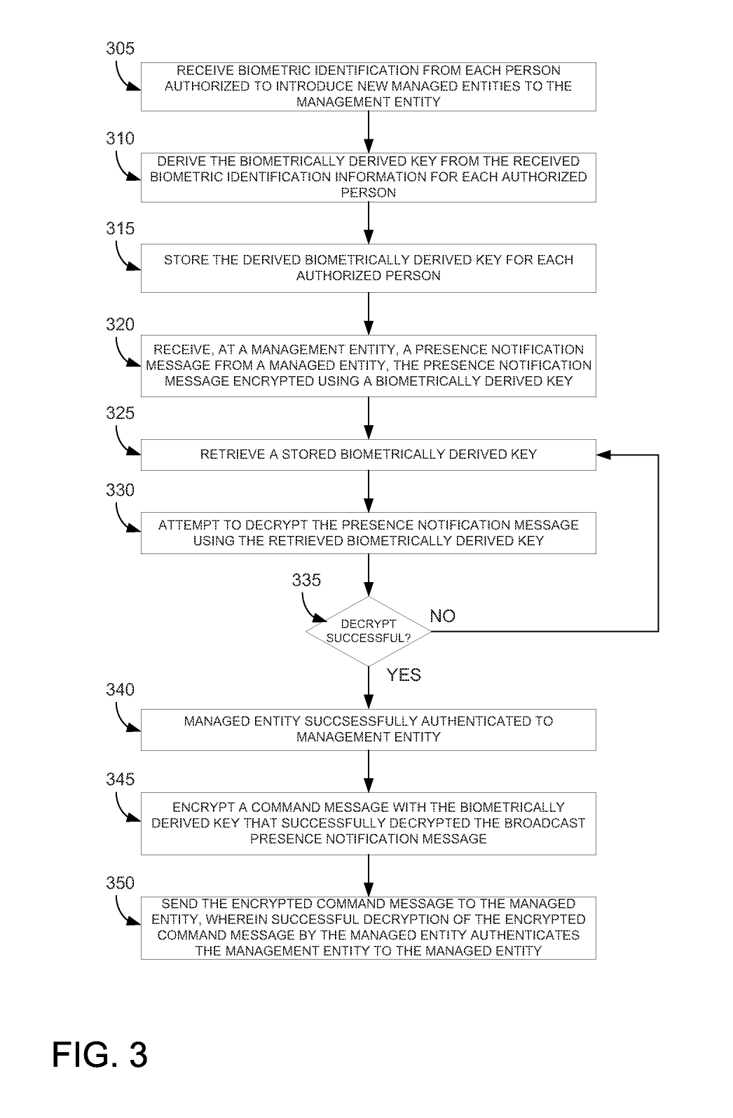

FIG. 3 is another example high level flow diagram for authenticating a managed entity using the techniques described herein. In block 305, biometric identification information may be received from each person authorized to introduce new managed entities to the management entity. In block 310, a biometrically derived key may be derived from the biometric identification information provided by each authorized person. In block 315, the biometrically derived key for each authorized person may be stored. As explained above, the biometrically derived keys may be stored within the management entity or an external authentication entity. What should be understood is that biometrically derived keys for each authorized person are available to the management entity.

In block 320, just as above, a presence notification message encrypted with a biometrically derived key may be received from a managed entity. In block 325, a stored biometrically derived key may be retrieved. For example, one of the keys generated in block 310 may be retrieved. In block 330, an attempt to decrypt the encrypted presence notification message may be made. In block 335, it may be determined if the decryption was successful. If not, the process moves to block 325, wherein another biometrically derived key may be retrieved.

If the decryption in block 335 is successful, the process moves to block 340. In block 340, the management entity has successfully authenticated the managed entity. In block 345, a command message may be encrypted with the biometrically derived key that was able to successfully decrypt the presence notification message in block 330. In block 350, the encrypted command message may be sent to the managed entity. If the managed entity is able to successfully decrypt the command message, this may mean that the management entity has authenticated itself to the managed entity.

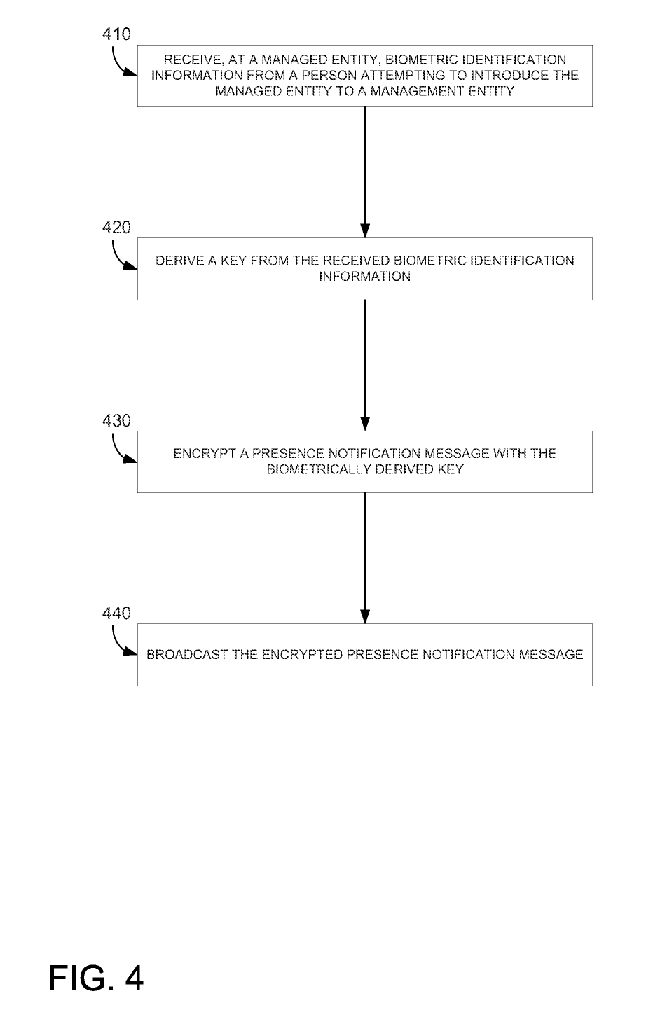

FIG. 4 is an example high level flow diagram for authenticating a management entity using the techniques described herein. In block 410, biometric identification information may be received at a managed entity from a person attempting to introduce a managed entity to a management system. In block 420, a key may be derived from the received biometric identification information. As mentioned above, the keys are derived such that biometric identification information from a given person will cause the same biometrically derived key to be generated.

In block 430, a presence notification message may be encrypted using the biometrically derived key generated in block 420. Thus, the managed entity can be ensured that only an entity which also knows the biometrically derived key can successfully decrypt the presence notification message. In block 440, the encrypted presence notification message may be broadcast. As explained above, the broadcast may be received by a management entity.

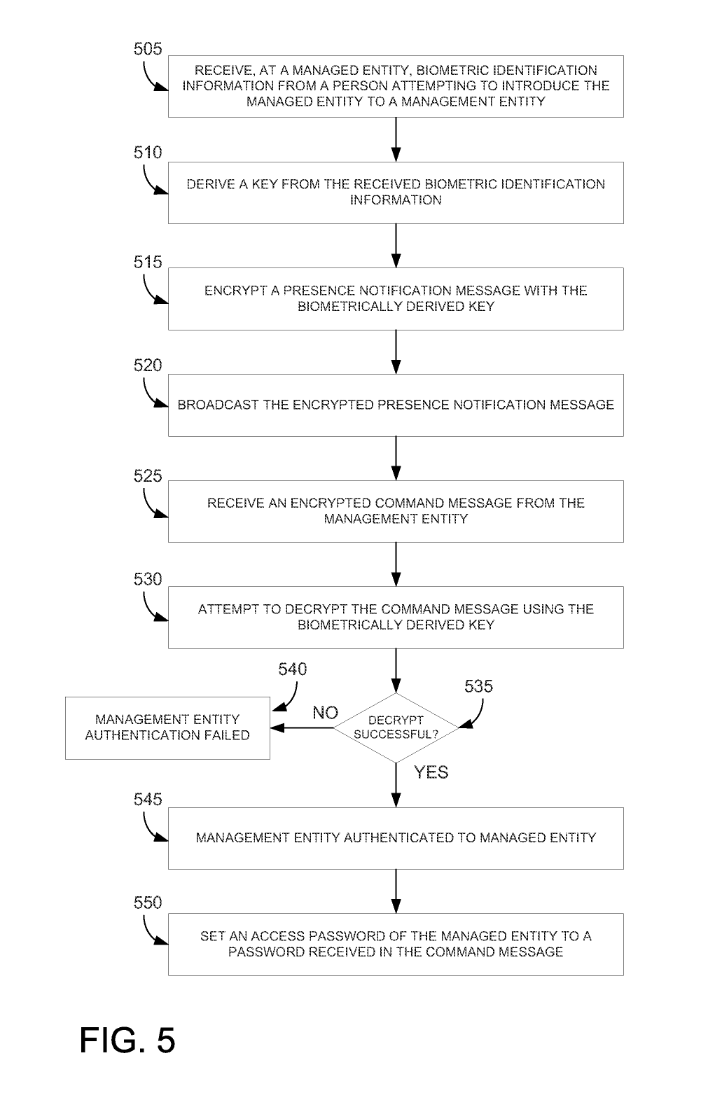

FIG. 5 is another example high level flow diagram for authenticating a management entity using the techniques described herein. In block 505, biometric identification information may be received form a person attempting to introduce a managed entity to a management entity. In block 510, a key may be derived from the biometric identification information. In block 515, a presence notification message may be encrypted with the biometrically derived key. In block 520, the encrypted presence notification message may be broadcast.

In block 525, an encrypted command message may be received from the management entity, As explained above, the management entity may generate the command message in response to successfully decrypting the presence notification message. In block 530, an attempt to decrypt the command message using the biometrically derived key may be made. In block 535, it may be determined if the decryption attempt was successful. If not, the process moves to block 540. In block 540, it may be determined that the management entity has failed authentication, and further action should not be taken.

If it is determined in block 535 that the command message was successfully decrypted, the process moves to block 545. In block 545, the management entity is now authenticated by the managed entity. In block 550, the managed entity may set an access password for the managed entity to a password received in the command message.

We claim:

1. A method comprising:
receiving, at a management entity, a presence notification message from a managed entity, the presence notification message encrypted using a biometrically derived key; and
while the presence notification message remains encrypted:
retrieving a stored biometrically derived key; and
attempting to decrypt the presence notification message using the retrieved biometrically derived key, wherein successful decryption of the presence notification message authenticates the managed entity to the management entity.

2. The method of claim 1 further comprising:
encrypting a command message with the biometrically derived key that successfully decrypted the broadcast presence notification message; and
sending the encrypted command message to the managed entity, wherein successful decryption of the encrypted command message by the managed entity authenticates the management entity to the managed entity.

3. The method of claim 1 further comprising:
receiving biometric identification from each person authorized to introduce new managed entities to the management entity;
deriving the biometrically derived key from the received biometric identification information for each authorized person; and
storing the derived biometrically derived key for each authorized person.

4. The method of claim 2 wherein the command message includes a set password command.

5. The method of claim 3 wherein the biometrically derived keys are stored by a role based authentication system, wherein the roll based authentication system includes an indication of personnel authorized to introduce new managed entities to the management entity.

6. The method of claim 3 wherein failure to decrypt the presence notification message indicates an attempt by an unauthorized person to introduce a managed entity to the management entity.

7. A non-transitory processor readable medium containing a set of instructions thereon which when executed by a processor cause the processor to:
receive, at a managed entity, biometric identification information from a person attempting to introduce the managed entity to a management entity;
derive a key from the received biometric identification information:
encrypt a presence notification message with the biometrically derived key; and
broadcast the encrypted presence notification message.

8. The non-transitory processor readable medium of claim 7 further comprising instructions to:
receive an encrypted command message from the management entity;
attempt to decrypt the command message using the biometrically derived key;
wherein successful decryption of the command message authenticates the management entity to the managed entity.

9. The non-transitory processor readable medium of claim 7 wherein the biometric identification information is received through a device integrated with the managed entity.

10. The non-transitory processor readable medium of claim 8 wherein the command message includes an instruction to set a password on the managed entity further comprising instructions to:
set an access password of the managed entity to a password received in the command message.

11. A system comprising:
a managed entity to encrypt a presence notification message with a biometrically derived key and broadcast the encrypted presence notification message over a network;
a management entity to receive an encrypted broadcast presence notification message and attempt to decrypt the message with a plurality of biometrically derived keys and to encrypt a command message with the biometrically derived key that was able decrypt the encrypted presence notification message and further to send the encrypted command message over the network to the managed entity; and
the network to connect the managed entity and the management entity.

12. The system of claim 11 further comprising:
the managed entity to receive the encrypted command message and decrypt the encrypted command message with the biometrically derived key.

13. The system of claim 11 further comprising:
an authentication entity to store biometrically derived keys and provide the biometrically derived keys to the management entity.

14. The system of claim 11 wherein the biometrically derived key is derived from a fingerprint.

15. The system of claim 11 wherein biometrically derived keys for all persons authorized to introduce a managed entity to the management entity are accessible by the management entity.
